(19) United States
(12) Patent Application Publication
(10) Pub. No.: US 2025/0015337 A1
(43) Pub. Date: Jan. 9, 2025

(54) METAL ION CELLS WITH GOOD LOW TEMPERATURE PERFORMANCE

(71) Applicant: Pacific Industrial Development Corporation, Ann Arbor, MI (US)

(72) Inventors: Bing Tan, Ann Arbor, MI (US); Yuhao Liao, Ann Arbor, MI (US); Andrew Rajewski, Clinton, MI (US)

(21) Appl. No.: 18/706,027

(22) PCT Filed: Nov. 16, 2022
(86) PCT No.: PCT/US2022/050035

§ 371 Date: Apr. 30, 2024

Related U.S. Application Data
(60) Provisional application No. 63/282,202, filed on Nov. 23, 2021.

(51) Int. Cl. H01M 10/0525; H01M 4/02; H01M 4/131; H01M 4/485; H01M 10/0567; H01M 10/0568; H01M 10/0569

(52) U.S. Cl. CPC H01M 10/0525; H01M 4/131; H01M 4/485; H01M 10/0567; H01M 10/0568; H01M 10/0569; H01M 2004/027; H01M 2004/028; H01M 2220/20; H01M 2300/0034; H01M 2300/0037

(57) ABSTRACT

A metal ion cell that includes a positive electrode with a cathode active material configured to store and release metal ions: a negative electrode with an anode active material that operates at a potential that is not less than 0.6 volts (V) versus Li/Lit; and an electrolyte that incorporates one or more (e.g., lithium) metal salts and a solvent mixture that includes 3-methoxypropionitrile (MPN) and at least one linear carbonate. The MPN in the electrolyte may have a mass ratio of ≥0.1 as compared to the at least one linear carbonate. The at least one linear carbonate includes one or more of dimethyl carbonate (DMC), diethyl carbonate (DEC), or ethyl methyl carbonate (EMC). The solvent mixture may also include a mixture of carbonates, such that the mass percentage of the linear carbonate ranges from 10% to 90% compared to the overall mass of the mixture of carbonates.

### CROSS-REFERENCE TO RELATED APPLICATIONS

This application claims the benefit of the filing date under 35 U.S.C. § 119 (e) of U.S. Provisional Application No. 63/282,202 filed Nov. 23, 2021, the entire contents of which is hereby incorporated herein by reference.

### FIELD

This invention generally relates to metal ion cells for use in an electric device, appliance, or vehicle. In addition, the present disclosure describes an electrochemical cell that may be used in a rechargeable battery, such as a lithium ion cell.

### BACKGROUND

The statements in this section merely provide background information related to the present disclosure and may not constitute prior art.

A lithium ion cell generally incorporates at least four main components: (1) an anode, (2) a cathode, (3) a separator, and (4) an electrolyte. The electrolyte in commercially available lithium ion cells usually includes a lithium salt dispersed in one or more organic carbonate solvents. The electrolyte provides the medium through which lithium ions are transported between the cathode and the anode. The reason for using carbonate solvents is mainly due to the stability they provide at the operating potentials for both the anode (e.g., graphite) and cathode (e.g., lithiated metal oxide).

The use of a lithium titanium oxide (LTO), such as Li₄Ti₅O₁₂, as an anode active material provides several advantages over the use of a graphite active material. These advantages include faster charging capability, better low temperature performance, and improved safety. However, commercially available LTO-based cells, also utilize organic carbonate-based electrolytes, even though the operating potential associated with lithium titanium oxide is much higher than that of graphite. Due to the properties exhibited by different carbonate solvents, the electrolyte generally includes a mixture of carbonates in order to achieve the necessary level of ionic conductivity and viscosity. Although cyclic carbonates, such as ethylene carbonate (EC) and propylene carbonate (PC) provide high dipole moments, they also exhibit high viscosity. Conversely, linear carbonates, such as dimethyl carbonate (DMC), diethyl carbonate (DEC), and ethyl methyl carbonate (EMC) offer low viscosity, but their dipole moments are low as well. By combining at least one cyclic carbonate with one or more linear carbonates, the electrolyte is capable of providing high ionic conductivity at room temperature as necessary for use in many practical applications. However, carbonate-based electrolytes, particularly linear carbonates, lack low temperature performance because of their high melting temperature. Thus, finding an alternative electrolyte for enhancing low temperature performance is of industrial interest.

### SUMMARY

This disclosure generally provides a metal ion cell for use in an electric device, appliance, or vehicle. In addition, the present disclosure describes an electrochemical cell that may be used in a rechargeable battery, such as a lithium ion cell.

The metal ion cell includes a positive electrode comprising a current collector and a cathode active material configured to store and release metal ions; a negative electrode comprising a current collector and an anode active material that operates at a potential that is not less than 0.6 volts (V) versus Li/Li+; and an electrolyte comprising one or more metal salts and a solvent mixture that includes 3-methoxypropionitrile (MPN) and at least one linear carbonate solvent.

According to one aspect of the present disclosure, the potential at which the anode active material operates is not less than 0.8 V versus Li/Lit. The MPN in the electrolyte may have a mass ratio of ≥0.1 as compared to the at least one linear carbonate solvent; alternatively, the MPN in the electrolyte has a mass ratio of ≥2.0 as compared to the at least one linear carbonate solvent; alternatively, the MPN in the electrolyte has a mass ratio of ≥4.0 as compared to the at least one linear carbonate solvent.

According to another aspect of the present disclosure, the at least one linear carbonate solvent may comprise one or more of dimethyl carbonate (DMC), diethyl carbonate (DEC), or ethyl methyl carbonate (EMC). When desirable, the solvent mixture in the electrolyte may further comprise a mixture of carbonate solvents, such that the mass percentage of the at least one linear carbonate solvent ranges from 10% to 90% as compared to the overall mass for the mixture of carbonate solvents. The solvent mixture in the electrolyte may also further comprise a mixture of carbonate solvents and one or more non-carbonate solvents, such that the mass percentage of the linear carbonate ranges from 10% to 90% compared to the overall mass for the mixture of carbonate and non-carbonate solvents. The one or more non-carbonate solvents may comprise a sulfone solvent or a fluorocarbon solvent.

According to another aspect of the present disclosure, the one or more metal salts may be lithium salts in which at least a portion thereof is LiPF6. Alternatively, the one or more lithium salts may be LiPF6, which comprises 100% of the lithium salts present in the electrolyte. The electrolyte may comprise a concentration of LiPF6 that is in the range from 0.1 molar (M) to 3.0 M; alternatively, the concentration of LiPF6 is in the range from 0.5 molar (M) to 1.5 M. The one or more lithium salts may also comprise >50 mole % LiPF6 among all of the lithium salts present. When desirable, the one or more lithium salts may further comprise at least one of lithium bis(trifluoro methane sulfonyl)imide (LIFTSi), lithium bis(fluorosulfonyl)imide (LiFSi), lithium tetrafluoroborate (LiBF4), lithium bis(oxalato)-borate (LiBOB), lithium difluoro (oxalato) borate (LiDFOB), lithium hypochlorite (LiClO4), and lithium difluorophosphate (LiPO2F2).

The cathode active material may comprise one or more of lithium iron phosphate (LFP), lithium iron manganese phosphate (LFMP), lithium manganese oxide (LMO), lithium nickel dioxide (LNO), lithium manganese nickel oxide (LMNO), lithium nickel manganese cobalt oxide (LMNC), lithium cobalt oxide (LCO), lithium vanadium phosphate (LVP), and metal fluorides.

The active anode material may comprise one or more of lithium titanate, titanium oxide, titanium niobium oxide with various titanium to niobium ratios, niobium oxide and its derivatives, tungsten oxide, molybdenum oxide, vanadium oxide, antimony, and antimony oxide.

According to another aspect of the present disclosure, the one or more metal salts may include sodium ions, potassium ions, magnesium ions, aluminum ions, lithium ions, or a mixture thereof. The one or more metal salts includes tetraethylammonium tetrafluoroborate at a concentration ranging from 0.3 to 1.8 M.

According to another aspect of the present disclosure, a battery or battery pack for use in an electric device, appliance, or vehicle (EV) is provided wherein the battery or battery pack comprises one or more of the cells as defined above and as further described herein. The battery or battery pack may include a plurality of the cells placed in series or in a parallel configuration in order to increase overall capacity.

According to yet another aspect of the present disclosure an electrochemical supercapacitor is provided, wherein the supercapacitor comprises at least one cell as defined above and further described herein that incorporates activated carbon in one of the positive electrode or the negative electrode.

Further areas of applicability will become apparent from the description provided herein. It should be understood that the description and specific examples are intended for purposes of illustration only and are not intended to limit the scope of the present disclosure.

### DESCRIPTION OF THE DRAWINGS

In order that the disclosure may be well understood, there will now be described various forms thereof, given by way of example, reference being made to the accompanying drawings. The components in each of the drawings may not necessarily be drawn to scale, but rather emphasis is placed upon illustrating the principles of the invention.

FIG. 1 is a schematic representation of an electrochemical cell comprising an anode active material, a cathode active material, an electrolyte, and a separator according to the teachings of the present disclosure;

FIG. 2 is a plot of the rate performance of lithium titanium oxide/lithium manganese oxide (LTO/LMO) in 3-methoxypropionitrile (MPN), diethyl carbonate (DEC), and a mixture thereof at −30° C.;

FIG. 3 is a plot of the rate performance of LTO/LMO in MPN, ethylene carbonate/diethyl carbonate (EC/DEC), and a mixture thereof at −30° C.; and

FIG. 4 is a plot of the rate performance of LTO/LMO in MPN, ethylene carbonate/dimethyl carbonate (EC/DMC), and a mixture thereof at −30° C.

The drawings described herein are for illustration purposes only and are not intended to limit the scope of the present disclosure in any way. It should be understood that throughout the description and drawings, corresponding reference numerals indicate like or corresponding parts and features.

### DETAILED DESCRIPTION

The following description is merely exemplary in nature and is in no way intended to limit the present disclosure or its application or uses. For example, the electrochemical cell prepared and used according to the teachings contained herein are described throughout the present disclosure as a lithium ion cell in order to more fully illustrate the structural elements and the use thereof. However, based on the working principle, the mixed solvent concept of the present disclosure may be applied to other metal ion cells, that utilize a salt derived from or including sodium ions, potassium ions, magnesium ions, aluminum ions, or a mixture thereof, provided the cell has an anode, which is operated at ≥0.6 V vs. Li/Lit. In addition, the incorporation and use of the mixed solvent system of the present disclosure may also be applied to electrochemical supercapacitors with activated carbon in one of its electrodes (e.g., cathode and anode). The LiPF₆ salt may be replaced by a non-Li salt, which includes, but not limited to, tetraethylammonium tetrafluoroborate, provided the salt concentration ranges from 0.3 to 1.8 molar (M). The incorporation and use of a plurality of such electrochemical cells in a variety of electrical devices, appliances, and systems, including without limitation, larger capacity rechargeable batteries or a battery or battery pack for an electric vehicle (EV) is contemplated to be within the scope of the present disclosure.

As used herein a “battery cell” or “cell” refers to the basic electrochemical unit of a battery that contains the electrodes, separator, and electrolyte. In comparison, a “battery” or “battery pack” refers to a collection of cell(s), e.g., one or more cells, and includes a housing, electrical connections, and possibly electronics for control and protection.

For the purpose of this disclosure, the terms “about” and “substantially” are used herein with respect to measurable values and ranges due to expected variations known to those skilled in the art (e.g., limitations and variability in measurements).

For the purpose of this disclosure, the terms “at least one” and “one or more of” an element are used interchangeably and may have the same meaning. These terms, which refer to the inclusion of a single element or a plurality of the elements, may also be represented by the suffix “(s)” at the end of the element. For example, “at least one metal”, “one or more metals”, and “metal(s)” may be used interchangeably and are intended to have the same meaning.

The present disclosure generally provides an electrolyte system for use in lithium ion cells, such as those that are based on lithium titanium oxide (LTO). The electrolyte system generally comprises LiPF₆ as the main lithium salt dispersed in a solvent that consists of, comprises, or consists essentially of a mixture of 3-methoxypropionitrile (MPN) and at least one organic carbonate solvent. Organic nitrile solvents, such as MPN generally exhibit lower viscosities than cyclic carbonates and higher dipole moments than linear carbonates. Organic nitrile solvents also have a low melting temperature, thereby, allowing for their use as a solvent in order to provide for more efficient battery cell performance at low temperatures.

In a battery cell, a lithium titanium oxide (LTO) anode is generally operated between about 1.0 V-3.0 V versus Li/Li⁺, while a graphite anode is operated between 0.01 V-1.0 V vs. Li/Li⁺. The minimum potential of an LTO anode is as high as about 1.0 V higher than the minimum potential of a graphite anode. This large potential difference allows for the use of an alternative solvent, e.g., a solvent other than organic carbonates, even if this solvent cannot be used with a graphite anode. For example, acetonitrile has a reduction potential at about 0.5 V vs. Li/Lit, which cannot be used with a graphite anode. However, acetonitrile may be able to be used with an LTO anode since its operating potential is much higher than 0.5 V vs Li/Lit. In another example, 3-methoxypropionitrile (MPN) may be used as a solvent for an electrolyte in a LTO-based cell with a lithium salt, such as LiTFSi or LiPF₆. An LTO-based cell with a LiTFSi salt dispersed in MPN exhibits acceptable performance. However, since LiPF₆ salts are the dominate lithium salt utilized in commercial cells, the cost associated with an LiTFSi salt makes the battery cell much more expensive to manufacture. Thus, an electrolyte for use with a LiPF₆-based salt dispersed in MPN for use in LTO-based cells is desirable.

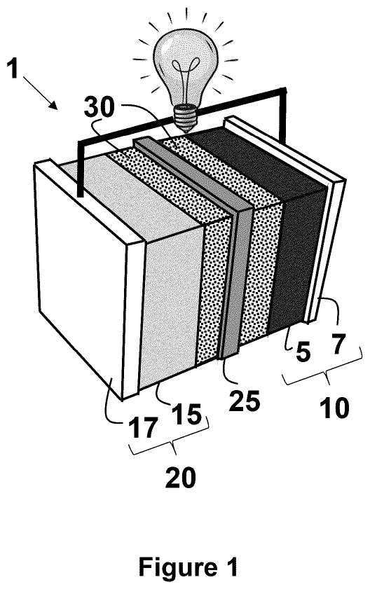

Referring to FIG. 1, the electrochemical cell 1 generally comprises a positive electrode 10 and a negative electrode 20. The positive electrode 10 includes an active cathode material 5 and a current collector 7, while the negative electrode 20 comprises an active anode material 15 and a current collector 17. In addition, the cell includes a non-aqueous electrolyte 30 containing metal (e.g., lithium) ions and a separator 25 ad described above and further defined herein. All of these components are sealed in a case, an enclosure, a pouch, a bag, a cylindrical shell, or the like (generally called the battery's “housing”). The separator 25 electrically insulates the cathode active material 5 from the anode 15, while still allowing metal (e.g., lithium) ions to flow between them. The flow of ions may be conducted by the presence of the liquid electrolyte 30 that permeates through the porosity of the separator 25 (e.g., a membrane).

Still referring to FIG. 1, the anode active material 15 may comprise a lithium titanium oxide (LTO) or any other anode active materials that can operate within a similar potential range or even a slightly lower potential limit. For example, instead of 1.0 V vs. Li/Lit, the anode active material 15 may be operated down to 0.6 V vs. Li/Li+, which may be still higher than the reduction of the nitrile (e.g., 0.5 V vs. Li/Li⁺). The anode active material 15 may also be operated down to 0.7 V vs. Li/Lit, 0.8 V vs. Li/Li⁺, or even 0.9 V vs. Li/Li⁺. As long as the minimum operating potential of the anode active material 15 is higher than the reduction potential of the MPN solvent, these anode active materials may be used to replace the LTO anode for any given application. Several examples of anode active materials 15 include, but are not limited to, lithium titanate (LTO), titanium oxide, titanium niobium oxide with various titanium to niobium ratios, niobium oxide and its derivatives, tungsten oxide, molybdenum oxide, vanadium oxide, antimony, and antimony oxide to name a few.

The cathode active materials 5 may be selected from any cathode active material that is currently available for use in a conventional lithium ion cell. Several examples of cathode active materials 5 include, without limitation, lithium iron phosphate (LFP), lithium iron manganese phosphate (LFMP), lithium manganese oxide (LMO), lithium nickel dioxide (LNO), lithium manganese nickel oxide (LMNO), lithium nickel manganese cobalt oxide (LMNC), lithium cobalt oxide (LCO), lithium vanadium phosphate (LVP), and metal fluorides.

Referring again to FIG. 1, an electrolyte 30 is positioned between and in contact with the negative electrode 20 and the positive electrode 10, such that the electrolyte 30 supports a reversible flow of metal (e.g., lithium) ions between the positive electrode 10 and the negative electrode 20. The separator 25 is configured to electrically isolate the positive electrode 10 from the negative electrode 20, while being permeable to the reversible flow of the metal (e.g., lithium) ions there through.

The electrolyte 30 is based on a hexafluorophosphate lithium salt (LiPF₆) with a molar concentration ranging from 0.1 moles (M) to 3.0 M; alternatively, from 0.2 M to 2.0 M; alternatively, from about 0.5 M to about 1.5 M. An electrolyte 30 wherein the concentration of the lithium salt is too high may result in the precipitation of the salt at low temperatures. When the concentration of the lithium salt is too low, the ionic conductivity of the electrolyte 30 may not be enough to allow for any practical usage. The lithium salt may be comprised of 100% LiPF₆. The lithium salt may also be a mixture of LiPF₆ with at least one additional lithium salt. In this mixture, the amount of LiPF₆ is high enough to make it the dominant lithium salt present. In other words, the molar percentage of lithium hexafluorophosphate (LiPF₆) with respect to the total lithium salt content of the mixture is >0.5; alternatively, ≥0.6; alternatively, ≥0.7. The at least one additional lithium salt may comprise, without limitation, lithium bis(trifluoro methane sulfonyl)imide (LIFTSi), lithium bis(fluorosulfonyl)imide (LiFSi), lithium tetrafluoroborate (LiBF₄), lithium bis(oxalato)-borate (LiBOB), lithium difluoro (oxalato) borate (LiDFOB), lithium hypochlorite (LiClO₄), lithium difluorophosphate (LiPO₂F₂), or a mixture thereof.

A mixture of solvents is used to disperse the lithium salt in the electrolyte 30. This mixture of solvents comprises 3-methoxypropionitrile (MPN) and at least one linear carbonate. The linear carbonate, which exhibits low viscosity, may comprise, but not be limited to, dimethyl carbonate (DMC), diethyl carbonate (DEC), or ethyl methyl carbonate (EMC). When desirable, the mixture of solvents used in the electrolyte may also include a cyclic carbonate, such as, without limitation, ethylene carbonate (EC) and propylene carbonate (PC). One skilled in the art will understand that the mixture of solvents used in the electrolyte 30 may also include a non-carbonate solvent without exceeding the scope of the present disclosure. Several examples of a non-carbonate solvent include, without limitation, sulfone and fluorocarbon solvents. The mass ratio of the MPN to the other solvents present in the electrolyte 30 is ≥0.1; alternatively, ≥1.0; alternatively, ≥2.0; alternatively, ≥4.0; and alternatively, ≥9.0. The mass percentage of the linear carbonate present in the solvent mixture may range from 10% to 90%; alternatively, about 15% to about 85%; alternatively 20% to 80%.

Referring now to Table 1, the benefit associated with the use a mixture of solvents according to the present disclosure is demonstrated. For a lithium titanium oxide/lithium manganese oxide (LTO/LMO) cell, the Coulombic Efficiency (CE) during the 1^{st} cycle with an electrolyte comprising 1 molar (M) LiPF₆ dispersed in MPN was 86%. When a mixture of the MPN and a linear carbonate (i.e., DEC) in a 1/1 ratio was used, the 1^{st} CE increased to 90%. When a mixture of ethylene carbonate and diethyl carbonate (EC/DEC or EC-DC) was mixed with the MPN in a 4/1 ratio, the 1^{st} CE increased to 92%. Similarly, the use of other carbonate solvents (e.g., EC-DMC) with MPN at various ratios, the 1^{st} CE ranged from 90% to 93%. Thus, mixing a carbonate solvent into a MPN electrolyte improves the 1^{st} CE of the LTO/LMO cell. This improvement in the 1^{st} CE is important for enhancing the use of the electrode materials to increase the energy density of the cell.

As used herein, Coulombic Efficiency (CE) is defined as the ratio of the discharge capacity (mAh/g) to the charge capacity (mAh/g). For each electrode (i.e., positive 10 or negative electrode 20), the CE is generally less than 100%, in particular, for the 1^{st} charge/discharge cycle because of irreversible capacity loss that occurs due to the occurrence of side reactions. For example, on the anode-side of the electrochemical cell (i.e., negative electrode 20), the organic electrolyte 30 may decompose at the low potential range and form a Solid Electrolyte Interface (SEI) film at the surface of the active anode material 15, which consumes capacity irreversibly. On the cathode-side of the electrochemical cell (i.e., positive electrode 10), the electrolyte 30 decomposition at the surface of the active cathode material 5 also occurs, but at a lower level than the decomposition that occurs on the active anode material 15. This decomposition may also result in the formation of an irreversible crystalline change.

TABLE 1
Comparison of 1^{st} CE from LTO/LMO
cells with various electrolytes

| | 1st CE (%) |
|---|---|
| 1M LiPF₆ in MPN | 86 |
| 1M LiPF₆ in MPN/DEC (1/1) | 90 |
| 1M LiPF₆ in MPN/EC-DEC (4/1) | 92 |
| 1M LiPF₆ in MPN/EC-DMC (4/1) | 90 |
| 1M LiPF₆ in MPN/EC-DMC (1/1) | 93 |

The active anode 15 and cathode 5 materials may be formed into the desired shape for use in the negative 20 and positive 10 electrodes by mixing the active materials with one or more binders in various mass ratios. For example, the cathode active material 5 comprising any cathode active material currently available for use in a conventional lithium ion cell with or without any additives may be mixed with a binder that includes, without limitation, polyvinylidene fluoride (PVDF), carboxymethylcellulose (cmc), polytetrafluoroethylene (PTFE), a polyacrylate, or a mixture or blend thereof. The anode active material 15 comprising lithium titanium oxide (LTO) or any other active materials that can operate within a similar potential range or even at a slightly lower potential limit may be mixed with a binder that includes, without limitation, carboxymethylcellulose (cmc), styrene butadiene rubber (SBR), a polyacrylic acid, a polyacrylate, a polyimide, or a mixture or blend thereof. The mass ratio of the active material (i.e., anode or cathode) to the binder may be in the range of 70:30 to 99.9:0.1; alternatively 70:30 to 99:1; alternatively, 80:20 to 99:1; alternatively, 80:20 to 95:5 with the larger ratio of active material to binder being used in applications requiring a higher energy density.

The current collector 7 in the positive 10 electrode may be made of any metal known in the art for use in an electrode of a lithium battery, such as for example, without limitation, aluminum, titanium, stainless steel, nickel, copper, carbon, zinc, gallium, silver, and combinations or alloys formed therefrom. The current collector 17 used in the negative electrode 20 may be a metallic foil that does not react with metal (e.g., lithium) ions. Several examples of such metallic foils may include, but not be limited to Cu, Fe, Ti, Ni, Mo, W, Zr, Mn, carbon, and lithium metal alloys. Alternatively, the metallic foil for the current collector 17 of the negative electrode 20 comprises Cu, Fe, Ni, or a mixture or alloy thereof. The current collectors 7, 17 used in one or more of the positive 10 and/or negative 20 electrodes may include at least one metal that is capable of forming an alloy with lithium.

The separator 25 ensures that the active anode cathode material 15 and the active cathode material 5 do not touch and allows metal (e.g., lithium) ions to flow there through. The separator 25 may be a polymeric membrane comprising, without limitation, polyolefin based materials with semi-crystalline structure, such as polyethylene, polypropylene, and blends thereof, as well as micro-porous poly(methyl methacrylate)-grafted, siloxane grafted polyethylene, and polyvinylidene fluoride (PVDF) nanofiber webs.

The specific examples provided in this disclosure are given to illustrate various embodiments of the invention and should not be construed to limit the scope of the disclosure. The embodiments have been described in a way which enables a clear and concise specification to be written, but it is intended and will be appreciated that embodiments may be variously combined or separated without parting from the invention. For example, it will be appreciated that all preferred features described herein are applicable to all aspects of the invention described herein.

Several LTO/LMO cells with various electrolytes were fabricated and evaluated. All battery materials were purchased from Gelon, P. R. China. The LMO coating was made from a mixture of lithium manganese oxide (LMO), carbon black (C65), carbon nanotubes (CNT), and polyvinylidene fluoride (PVDF) in a mass ratio of 92/2/2/4, such that the coating exhibited an areal capacity loading of about 0.8 mAh/cm². The LTO coating was made from a mixture of lithium titanium oxide (LTO), carbon black (C65), and PVDF in a mass ratio of 92/5/3, such that the coating exhibited an areal capacity loading of about 0.8 mAh/cm². A full or complete cell was fabricated by stacking one LMO electrode, one ceramic oxide-coated PE separator, and one LTO electrode in an aluminum pouch with the pouch being filled with a predetermined electrolyte type and amount. The full or complete cell was then cycled between 3.0 V and 4.2 V at different C rates with C/10 being the slowest rate at room temperature and −30° C. to demonstrate the advantage of using an MPN-based electrolyte in combination with at least one carbonate solvent. For the purpose of this disclosure, a C rate is a measure of the rate at which a battery is discharged relative to its maximum capacity.

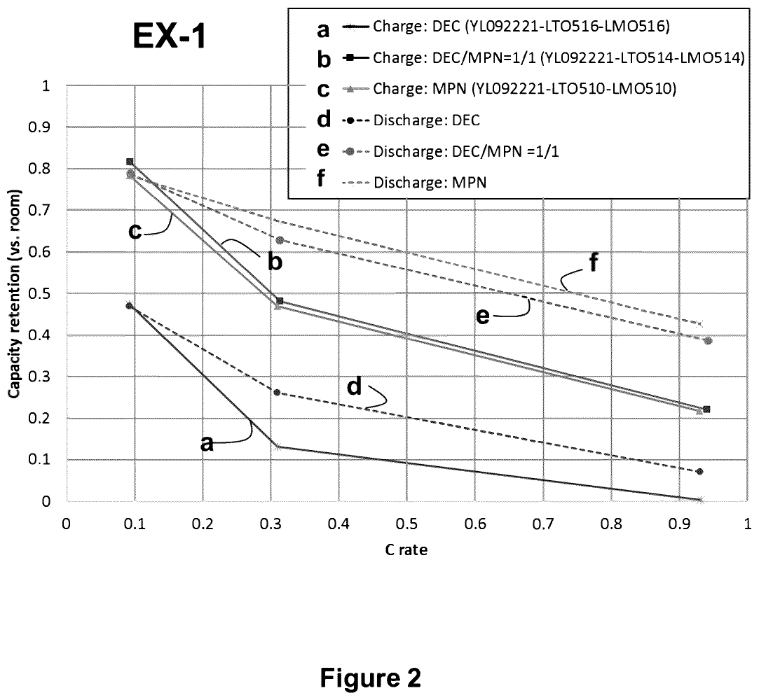

Referring now to FIG. 2, a plot of the rate performance of lithium titanium oxide/lithium manganese oxide (LTO/LMO) in 3-methoxypropionitrile (MPN), diethyl carbonate (DEC), and a mixture thereof at −30° C. is provided. In this example (EX-1), the capacity retention for the LTO/LMO cell with 1 M LiPF₆ in DEC at −30° C. was about 47% of the capacity at room temperature (see curves a, d). The capacity retention for the LTO/LMO cell with 1 M LiPF₆ in MPN/DEC (1/1 mass ratio) at −30° C. was about 82% at about a C/10 charge/discharge rate (see curves b, e), while the capacity retention was about 78% for a cell that used a pure 100% MPN solvent (see curve c, f).

The enhancement in low temperature performance is substantial or significant when using a solvent mixture of MPN and a carbonate (see curves b, e) as compared to only a carbonate solvent (see curves a, d). The mixed solvent (see curves b, e) even showed slightly better capacity retention than the pure MPN (see curves c, f) at low temperatures. Although not wanting to be held strictly to theory, it is believed that the improvement in capacity retention exhibited by the mixed solvent over pure MPN may be caused by the MPN having a relatively large viscosity, whereby, the addition of a low viscosity carbonate solvent helps to improve the ionic conductivity that occurs at low temperatures.

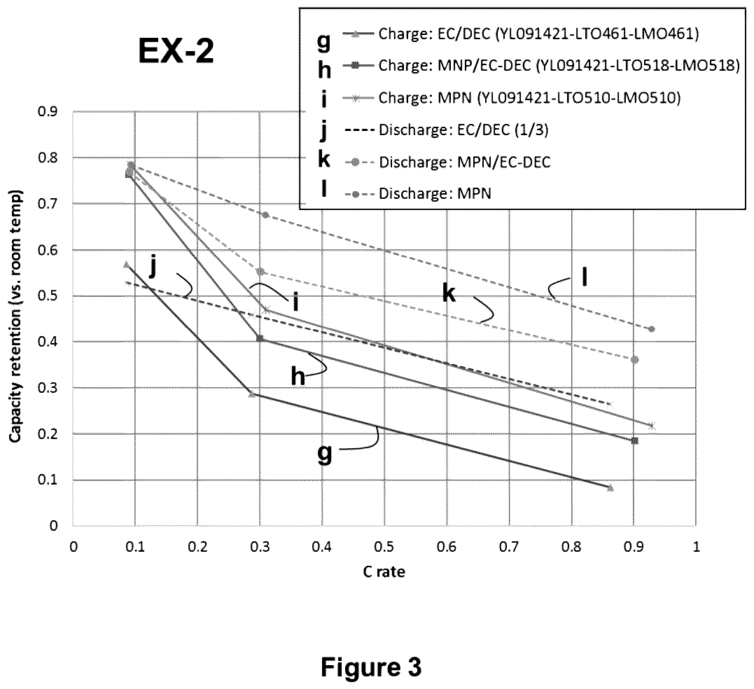

Referring now to FIG. 3, a plot of the rate performance of LTO/LMO in MPN, ethylene carbonate/diethyl carbonate (EC/DEC), and a mixture thereof at −30° C. is provided. In this example (EX-2), a 1 M LiPF₆ in MPN electrolyte was prepared and mixed with a commercial 1 M LiPF₆ in EC/DEC (1/3), which also included 1% vinylene carbonate (VC) and 1% fluoroethylene carbonate (FEC). The cell containing only the commercial electrolyte had a capacity retention of about 57% at −30° C. at about a C/10 rate (see curves g, j), while the cell with the solvent mixture according the present disclosure showed about a 77% capacity retention (see curves h, k). The capacity retention of the solvent mixture (see curves h, k) is similar to the 78% capacity retention for the cell containing 100% MPN (see curves i, l). The addition of the commercial carbonate electrolyte to the MPN electrolyte increased the 1^{st} CE as compared to the MPN electrolyte, while maintaining a similar capacity retention at −30° C.

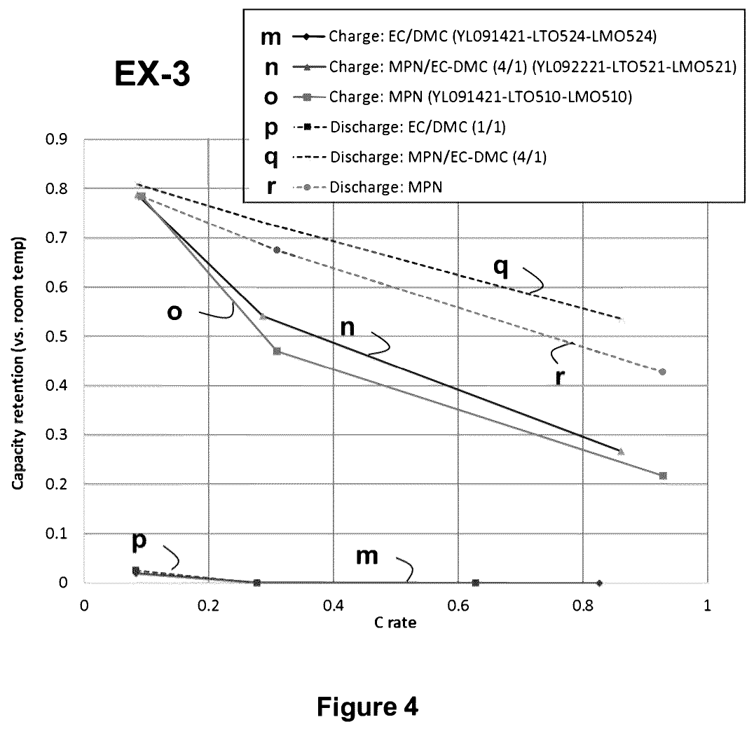

Referring now to FIG. 4, a plot of the rate performance of LTO/LMO in MPN, ethylene carbonate/dimethyl carbonate (EC/DMC), and a mixture thereof at −30° C. is provided. In this example (EX-3), a 1 M LiPF₆ in MPN electrolyte was prepared and mixed with a commercial 1 M LiPF₆ in EC/DMC (1/1) electrolyte. At −30° C., the capacity retention for the cell containing only the EC/DMC electrolyte was close to 0 (see curves m, p) because of the high melting temperatures of the solvents EC and DMC. The cell containing the electrolyte comprising the solvent mixture of MPN and carbonates (4/1) showed the highest capacity retention at about C/10 charge/discharge rate, which was 81% (see curves n, q) as compared to 78% for the cell containing the 100% MPN electrolyte (see curves o, r). Moreover, the cell containing the electrolyte comprised of the MPN and carbonate solvent mixture exhibited a better discharge rate capability (see curve q versus curve r).

The examples (EX-1, EX-2, EX-3) demonstrate several of the advantages associated with the electrolyte of the present disclosure, which includes a mixture of MPN with at least one carbonate solvent. More specifically, the use of the solvent mixture improves the 1^{st} CE exhibited by the cell, while maintaining or even enhancing performance at low temperatures.

According to yet another aspect of the present disclosure, one or more of the electrochemical cells may be combined to form a larger capacity battery or battery pack, such as used in a larger capacity lithium-ion secondary battery or in a battery pack incorporated into an electric vehicle (EV). The one or more electrochemical cells may be incorporated in series, in parallel, or in a combination thereof in order to form the battery or battery pack. One skilled in the art will also appreciate that in addition to using the electrochemical cells in a lithium-ion secondary battery, the same principles may be used to encompass or encase one or more of these electrochemical cells into a housing for use in another application.

The housing may be constructed of any material known for such use in the art and be of any desired geometry required or desired for a specific application. For example, lithium-ion batteries generally are housed in three different main form factors or geometries, namely, cylindrical, prismatic, or soft pouch. The housing for a cylindrical battery may be made of aluminum, steel, or the like. Prismatic batteries generally comprise a housing that is rectangular shaped rather than cylindrical. Soft pouch housings may be made in a variety of shapes and sizes. These soft housings may be comprised of an aluminum foil pouch coated with a plastic on the inside, outside, or both. The soft housing may also be a polymeric-type encasing. The polymer composition used for the housing may be any known polymeric materials that are conventionally used in lithium-ion secondary batteries. One specific example, among many, include the use of a laminate pouch that comprises a polyolefin layer on the inside and a polyamide layer on the outside.

Within this specification, embodiments have been described in a way which enables a clear and concise specification to be written, but it is intended and will be appreciated that embodiments may be variously combined or separated without parting from the invention. For example, it will be appreciated that all preferred features described herein are applicable to all aspects of the invention described herein.

Those skilled-in-the-art, in light of the present disclosure, will appreciate that many changes can be made in the specific embodiments which are disclosed herein and still obtain alike or similar result without departing from or exceeding the spirit or scope of the disclosure. One skilled in the art will further understand that any properties reported herein represent properties that are routinely measured and can be obtained by multiple different methods. The methods described herein represent one such method and other methods may be utilized without exceeding the scope of the present disclosure.

The foregoing description of various forms of the invention has been presented for purposes of illustration and description. It is not intended to be exhaustive or to limit the invention to the precise forms disclosed. Numerous modifications or variations are possible in light of the above teachings. The forms discussed were chosen and described to provide the best illustration of the principles of the invention and its practical application to thereby enable one of ordinary skill in the art to utilize the invention in various forms and with various modifications as are suited to the particular use contemplated. All such modifications and variations are within the scope of the invention as determined by the appended claims when interpreted in accordance with the breadth to which they are fairly, legally, and equitably entitled.

1. A metal ion cell, the cell comprising:
a positive electrode comprising a current collector and a cathode active material configured to store and release metal ions;
a negative electrode comprising a current collector and an anode active material that operates at a potential that is not less than 0.6 volts (V) versus Li/Lit; and
an electrolyte comprising one or more metal salts and a solvent mixture that includes 3-methoxypropionitrile (MPN) and at least one linear carbonate solvent.

2. The cell according to claim 1, wherein the potential at which the anode active material operates is not less than 0.8 V versus Li/Li⁺.

3. The cell according to claim 1, wherein the MPN in the electrolyte has a mass ratio of ≥0.1 as compared to the at least one linear carbonate solvent.

4. The cell according to claim 1, wherein the MPN in the electrolyte has a mass ratio of ≥2.0 as compared to the at least one linear carbonate solvent.

5. The cell according to claim 1, wherein the MPN in the electrolyte has a mass ratio of ≥4.0 as compared to the at least one linear carbonate solvent.

6. The cell according to claim 1, wherein the at least one linear carbonate solvent comprises one or more of dimethyl carbonate (DMC), diethyl carbonate (DEC), or ethyl methyl carbonate (EMC).

7. The cell according to claim 1, wherein the solvent mixture in the electrolyte further comprises a mixture of carbonate solvents, such that the mass percentage of the at least one linear carbonate solvent ranges from 10% to 90% as compared to the overall mass for the mixture of carbonate solvents.

8. The cell according to claim 1, wherein the solvent mixture in the electrolyte further comprises a mixture of carbonate solvents and one or more non-carbonate solvents, such that the mass percentage of the linear carbonate ranges from 10% to 90% compared to the overall mass for the mixture of carbonate and non-carbonate solvents.

9. The cell according to claim 8, wherein the one or more non-carbonate solvents comprises a sulfone solvent or a fluorocarbon solvent.

10. The cell according to claim 1, wherein at least one of the following is present:
the one or more metal salts are lithium salts in which at least a portion thereof is LiPF₆;
the cathode active material comprises one or more of lithium iron phosphate (LFP), lithium iron manganese phosphate (LFMP), lithium manganese oxide (LMO), lithium nickel dioxide (LNO), lithium manganese nickel oxide (LMNO), lithium nickel manganese cobalt oxide (LMNC), lithium cobalt oxide (LCO), lithium vanadium phosphate (LVP), and metal fluorides; and
the active anode material comprises one or more of lithium titanate, titanium oxide, titanium niobium oxide with various titanium to niobium ratios, niobium oxide and its derivatives, tungsten oxide, molybdenum oxide, vanadium oxide, antimony, and antimony oxide.

11. (canceled)

12. (canceled)

13. The cell according to claim 10, wherein the electrolyte comprises a concentration of LiPF₆ that is in the range from 0.1 molar (M) to 3.0 M.

14. The cell according to claim 13, wherein the concentration of LiPF₆ is in the range from 0.5 molar (M) to 1.5 M.

15. The cell according to claim 10, wherein the one or more lithium salts is LiPF₆, which comprises 100% of the lithium salts present in the electrolyte.

16. The cell according to claim 10, wherein the one or more lithium salts comprises >50 mole % LiPF₆ among all of the lithium salts present.

17. The cell according to claim 10, wherein the one or more lithium salts further comprises at least one of lithium bis(trifluoro methane sulfonyl)imide (LIFTSi), lithium bis(fluorosulfonyl)imide (LiFSi), lithium tetrafluoroborate (LiBF₄), lithium bis(oxalato)-borate (LiBOB), lithium difluoro (oxalato) borate (LiDFOB), lithium hypochlorite (LiClO₄), and lithium difluorophosphate (LiPO₂F₂).

18. The cell according to claim 1, wherein the one or more metal salts includes sodium ions, potassium ions, magnesium ions, aluminum ions, lithium ions, or a mixture thereof.

19. The cell according to claim 1, wherein the one or more metal salts includes tetraethylammonium tetrafluoroborate at a concentration ranging from 0.3 to 1.8 M.

20. A battery or battery pack for use in an electric device, appliance, or vehicle (EV), wherein the battery or battery pack comprises one or more of the cells according to claim 1.

21. The battery or battery pack according to claim 20, wherein the battery or battery pack includes a plurality of the cells placed in series or in a parallel configuration in order to increase overall capacity.

22. An electrochemical supercapacitor, wherein the supercapacitor comprises at least one cell according to claim 1 that incorporates activated carbon in one of the positive electrode or the negative electrode.
